(19) United States
(12) Patent Application Publication
(10) Pub. No.: US 2003/0019259 A1
(43) Pub. Date: Jan. 30, 2003

(54) Retainer lock

(76) Inventors: Wayne F. Nicodemus, Indianapolis, IN (US); William S. Meyers, Fishers, IN (US)

Correspondence Address: BOSE MCKINNEY & EVANS LLP, 135 N PENNSYLVANIA ST, SUITE 2700, INDIANAPOLIS, IN, 46204, US

(21) Appl. No.: 10/182,066

(22) PCT Filed: Feb. 1, 2001
(86) PCT No.: PCT/US01/03348

(51) Int. Cl. F16B 41/00; B62H 5/00; E05B 71/00

(52) U.S. Cl. 70/233; 70/232; 411/910

(57) ABSTRACT

The present invention relates to locking devices and in particular to apparatus and methods for securing components to a bicycle frame (60). A first exemplary embodiment of a locking device (100) includes a first retainer (120), a second retainer (170) and a key (190). The first retainer (120) includes a coupler (124) which is configured to couple with a coupler (196) on key (190). The first retainer (120) further includes a first radial surface (130) having a frusto-conical configuration. The second retainer (170) includes a tab member (174) configured to prevent the rotation of the second retainer (170) relative to the bicycle frame (60). In a second exemplary embodiment of a locking device (300) includes a first retainer (320), a sleeve (360), a second retainer, and a key. The first retainer (320) includes a coupler (324) which is configured to couple with a coupler on the key. Sleeve (360) is configured to at least partially receive first retainer (320) and includes a tab member (364) configured to prevent the rotation of the sleeve relative to the bicycle frame (60).

### REFERENCE TO PRIORITY APPLICATION

This application claims the benefit of U.S. Provisional Application No. 60/178,935, filed Feb. 1, 2000.

### TECHNICAL FIELD OF THE INVENTION

The present invention relates to locking devices and in particular to appratus and methods for securing components to a bicycle.

### BACKGROUND AND SUMMARY OF THE INVENTION

Bicycles are susceptible to theft when only the front wheel of the bicycle is secured to a bicycle rack or other object. Conventional bicycles are stolen by using a tool to loosen or remove the retainers holding the front wheel onto the bicycle frame. Especially susceptible are bicycles incorporating a quick release mechanism. Quick release mechanisms are popular because they allow bicycle wheels to be easily removed or bicycle seats to be easily adjusted in height. However, in order to protect against theft the owner of a bicycle with a quick release mechanism must remove the front wheel from the bicycle and secure both the front wheel and the bicycle frame to an object.

The present invention secures components, such as bicycle wheels or seats, to the frame of a bicycle such that the components cannot be easily removed without either using a corresponding key or by damaging the bicycle.

In a first exemplary embodiment, a locking device configured to secure a bicycle wheel having an hub with an axial channel to a bicycle frame comprises a rod adapted to pass through the axial channel of the hub. The rod comprises a first threaded portion and a second threaded portion. The locking device further comprises a first retainer comprising a body member and a coupler. The body member of the first retainer being configured to be coupled to the first threaded portion of the rod. The coupler of the first retainer comprising a plurality of receiving portions. The locking device further comprises a second retainer comprising a body member configured to be coupled to the second threaded portion of the rod and a tab member configured to limit rotation of the second retainer relative to the frame. The locking device further comprising a key comprising a plurality of protruding portions. Each one of the receiving portions of the first retainer is configured to couple one of the protruding portions of the key.

In a second exemplary embodiment, a locking device configured to secure a bicycle wheel having a hub with an axial channel to a bicycle frame comprises a rod adapted to pass through the axial channel of the hub. The rod comprises a first threaded portion and a second threaded portion. The locking device further comprises a first retainer comprising a body member and a coupler. The body member of the first retainer being configured to be coupled to the first threaded portion of the rod. The locking device further comprises a second retainer comprising a body member configured to be coupled to the second threaded portion of the rod and a tab member configured to limit rotation of the second retainer relative to the frame. The locking device further comprises a key comprising a body member and a coupler configured to couple the coupler of the first retainer. The locking device further comprises a sleeve comprising a body member and a tab member. The body member of the sleeve configured to partially receive the first retainer. The tab member of the sleeve configured to limit rotation of the sleeve relative to the frame.

In a third exemplary embodiment, a locking device configured to secure a bicycle wheel having an axle with a first threaded portion and a second threaded portion to a bicycle frame comprises a first retainer comprising a body member and a coupler. The body member of the first retainer being adapted to be coupled to the first threaded portion of the axle. The coupler of the first retainer comprising a plurality of receiving portions positioned in a first configuration. The locking device further comprises a second retainer comprising a body member adapted to be coupled to the second threaded portion of the axle and a coupler comprising a plurality of receiving portions positioned in a second configuration. The second configuration of the receiving portions of the second retainer matching the first configuration of the receiving portions of the first retainer. The locking device further comprises a key comprising a plurality of protruding portions. Each one of the receiving portions of the first retainer configured to couple one of the protruding portions of the key.

In a fourth exemplary embodiment, a locking device configured to secure a bicycle wheel having an axle with a first threaded portion and a second threaded portion to a bicycle frame comprises a first retainer comprising a body member and a coupler. The body member of the first retainer being adapted to be coupled to the first threaded portion of the axle. The locking device further comprises a second retainer comprising a body member adapted to be coupled to the second threaded portion of the axle and a coupler. The locking device further comprises a key comprising a body member and a coupler. The coupler of the key being configured to couple the coupler of the first retainer and the coupler of the second retainer. The locking device further comprises a sleeve comprising a body member and a tab member. The body member of the sleeve configured to partially receive the first retainer. The tab member adapted to limit rotation of the sleeve relative to the frame.

### BRIEF DESCRIPTION OF THE DRAWINGS

FIG.1 is a partial isometric view of a bicycle wheel and fork frame member of a bicycle which uses a quick release mechanism including a portion of a first illustrative embodiment of the present invention;

FIG. 2 is an exploded, isometric view of the components of a first illustrative embodiment of the present invention;

FIG. 3 is a side view of an illustrative embodiment of a first retainer of the present invention;

FIG. 4 is a front view of the first retainer of FIG. 3;

FIG. 5 is a diagrammatical representation of an illustrative placement criteria for the coupler of the first retainer of FIG. 4;

FIG. 6 is a side view of an illustrative embodiment of a second retainer of the present invention;

FIG. 7 is a front view of the second retainer of FIG. 6;

FIG. 8 is a partial, cutaway, side view of an illustrative embodiment of a key of the present invention;

FIG. 9 is a rear view of the key of FIG. 8;

FIG. 10 is an exploded, cross-sectional view of an exemplary sleeve and a first retainer which are part of a second illustrative embodiment of the present invention;

FIG. 11 us an unexploded view of FIG. 10;

FIG. 12 is an exploded, isometric view of the components of a third illustrative embodiment of the present invention;

FIG. 13 is a side view of a another illustrative embodiment of a first retainer of the present invention;

FIG. 14 is a front view of the second retainer of FIG. 13;

FIG. 15 is a side view of another illustrative embodiment of a key of the present invention; and

FIG. 16 is an exploded, side view of the components of a fourth illustrative embodiment of the present invention;

### DETAILED DESCRIPTION OF EXEMPLARY EMBODIMENTS

While the invention is susceptible to various modifications and alternative forms, exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

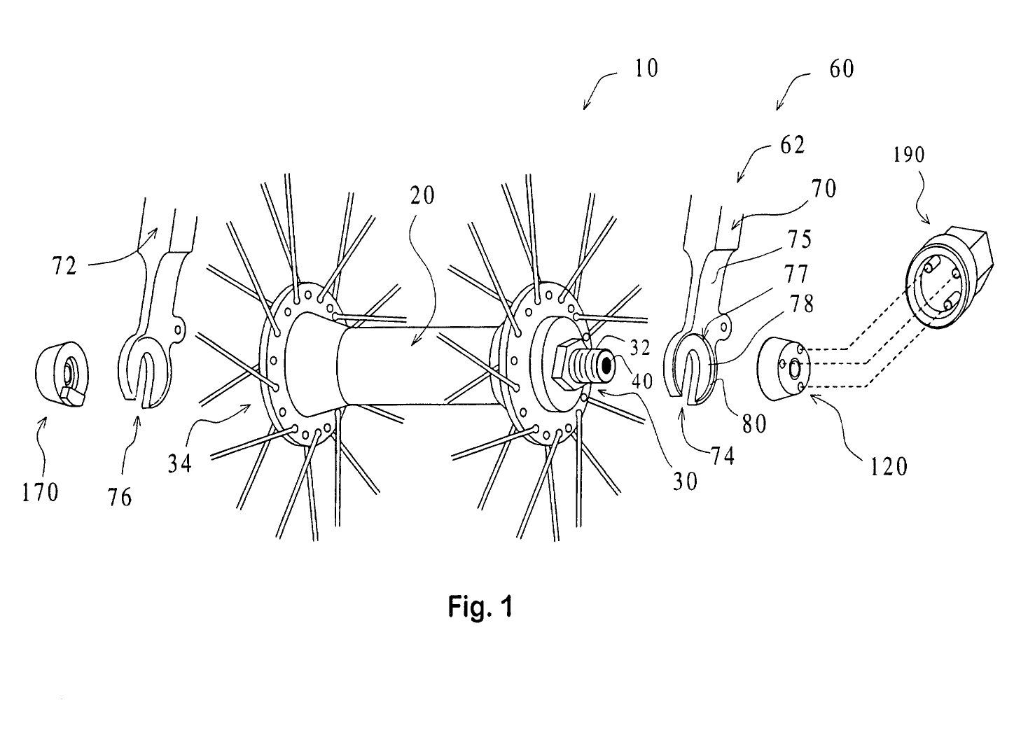

Referring to FIG. 1, a bicycle wheel 10 including a hub 20 being configured to function with a quick release mechanism is shown along with a portion of a bicycle frame 60. Bicycle frame 60 includes a fork member 62 having a first fork arm 70 and a second fork arm 72. First fork arm 70 and second fork arm 72 include apertures or receiving portions 74 and 76, respectively. First fork arm 70 further includes a pocket 77 formed in fork surface 75. Pocket 77 includes a bottom surface 78 and a wall surface 80. Second fork arm 72 contains a pocket similar to pocket 77.

Bicycle hub 20 includes an axle 30 having a first threaded portion 32 and a second threaded portion 34. Bicycle hub 20 is designed to accept a quick release mechanism for attaching bicycle wheel 10 to bicycle frame 60. In order to accommodate the quick release mechanism, axle 30 includes an axial channel 40 which has a generally circular axial cross section and which is concentric with axle 30. Channel 40 accepts a rod which couples a first portion of a quick release mechanism positioned proximate to first fork arm 70 to a second portion of a quick release mechanism positioned proximate to second fork arm 72.

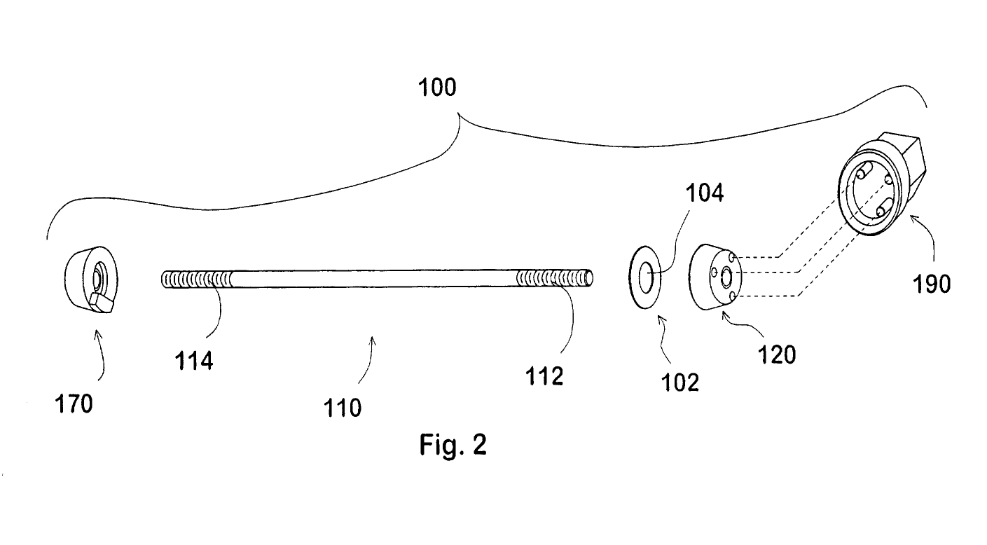

Referring to FIG. 2, an exemplary embodiment of a locking device 100 is shown. Locking device 100 includes a rod 110, a washer 102, a first retainer 120, a second retainer 170, and a key 190. Alternatively, locking device 100 does not include washer 102. Alternatively, when used with a conventional bicycle hub, locking device 100 includes a first retainer 120, a second retainer 170 and a key 190.

Rod 110 is not required with a conventional bicycle hub because the axle length of a conventional hub extends beyond first fork member 70 and second fork member 72 a length sufficient to directly couple first retainer 120 and second retainer 170. As such, when axle 30 is of sufficient length, first retainer 120 couples with first threaded portion 32 of axle 30, second retainer 170 couples with second threaded portion 34 of axle 30 and rod 110 is not required.

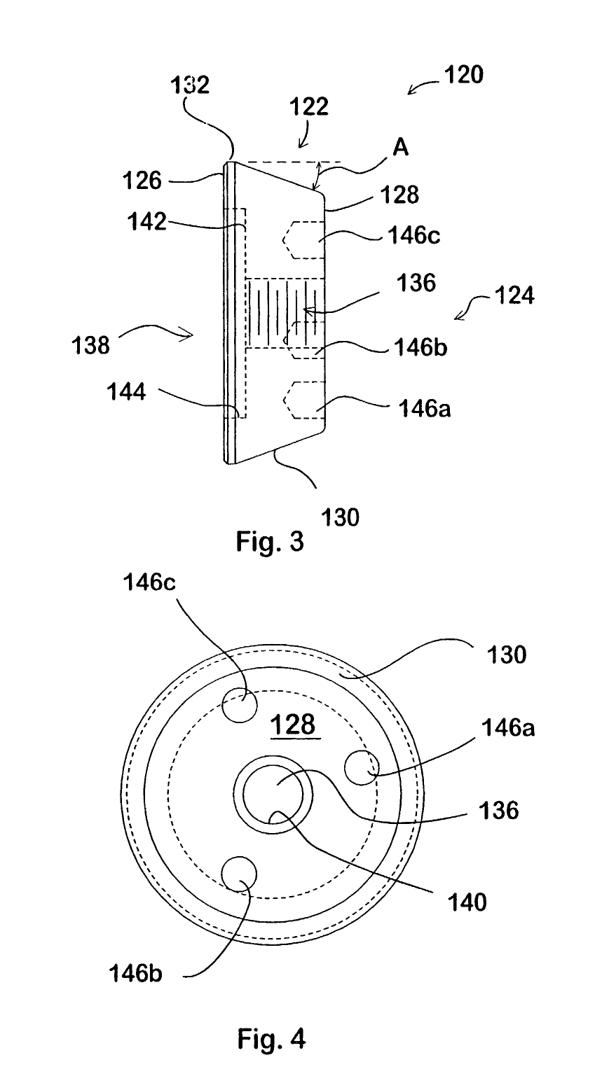

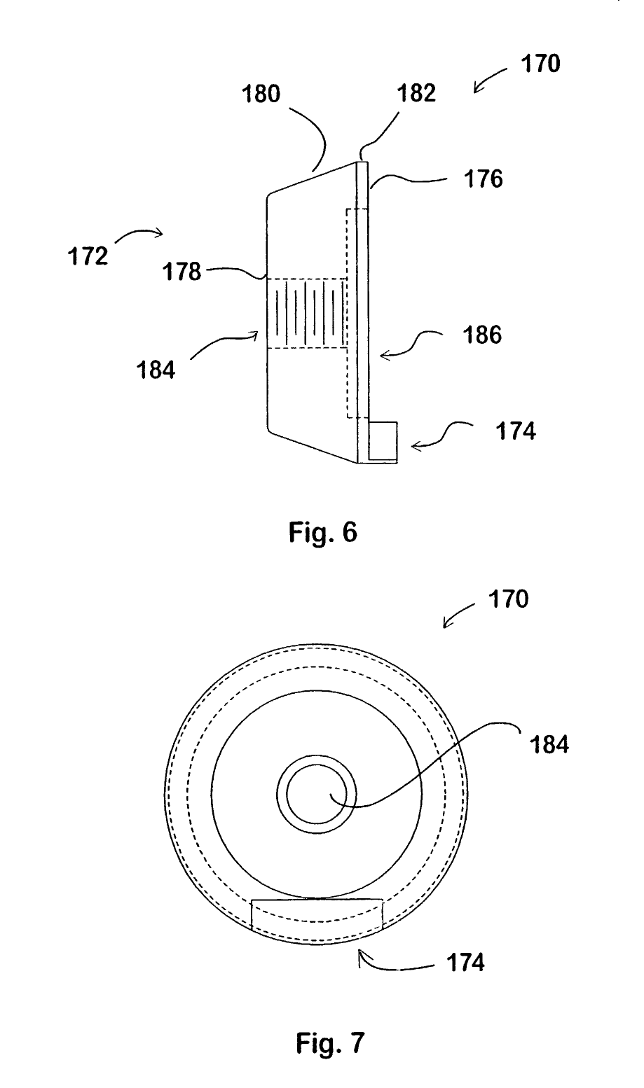

In an exemplary embodiment, first retainer 120 and second retainer 170 include the features set forth in connection with FIGS. 3, 4, 6 and 7. In another exemplary embodiment, second retainer 170 is configured generally identical to first retainer 120. As such, second retainer 170 includes a coupler and second retainer 170 does not include a tab member.

Rod 110 is generally cylindrical and includes a first threaded portion 112 and a second threaded portion 114. First threaded portion 112 and second threaded portion 114 are configured to threadably couple first retainer 120 and second retainer 170, respectively. In one exemplary embodiment, rod 110 is manufactured from a high grade steel. The length of rod 110 is chose based upon the application. For instance, rod 110 in an exemplary embodiment is longer when a rear wheel is to be secured by locking device 100 as opposed to when a front wheel is to be secured by locking device 100.

Referring to FIGS. 2, 3 and 4, first retainer 120 includes a body member 122 and a coupler 124. Body member 122 includes a generally circular first axial surface 126, a generally circular second axial surface 128, a first radial surface 130 and a second radial surface 132. First axial surface 126 and second axial surface 128 have a generally circular configuration to provide a generally cylindrical configuration for radial surface 130. A generally cylindrical radial surface is preferred to a faceted surface because a generally cylindrical surface cannot as easily be gripped by a tool, such as a wrench. One drawback with a cylindrical configuration is that such a configuration allows for a tool to apply pressure to body member 122 along the axial extent of the radial surface 130.

In the exemplary embodiment shown in FIGS. 2, 3 and 4, second axial surface 128 has a generally smaller diameter compared to the diameter of first axial surface 126, thereby causing radial surface 130 to have a frusto-conical shape. The frusto-conical configuration of surface 130 reduces the axial extent by which a tool having a linear profile can exert pressure. It is preferred that the diameters of first axial surface 126 and second axial surface 128 be selected such that the angle A, shown in FIG. 3, has a value in the range of 15°, to 60°. Even more preferably, angle A should have a value in the range of 20° to 45°. Most preferably the value of angle A should be 20°.

The second radial surface 132 of body member 122 has a generally cylindrical configuration and has a smaller axial extent than radial surface 130. The axial extent of radial surface 132 should be minimized in order to prevent the gripping of surface 132 with a tool. Ideally second radial surface 132 would not be present in first retainer 120 and radial surface 130 would terminate at first axial surface 126. However, the addition of radial surface 132 reduces the manufacturing cost of first retainer 120. Preferably the axial extent of radial surface 132 is in the range of 0.005″ (0.13 mm) and 0.060″ (1.52 mm). More preferably the axial extent of radial surface 132 is not larger than 0.030″ (0.76 mm).

Body member 122 further includes a channel 136 and a pocket 138. Channel 136 is defined by a radially, inward-facing surface 140 that is concentric with radial surfaces 130 and 132 and which extends from first axial surface 126 through to second axial surface 128. Channel 136 includes a threaded portion configured to couple with first threaded portion 112 of rod 110. Pocket 138 is defined by a third axial surface 142 and a second radially, inward-facing surface 144. Pocket 138 is configured to provide clearance for axle 30 when first retainer 120 is adjacent axle 30.

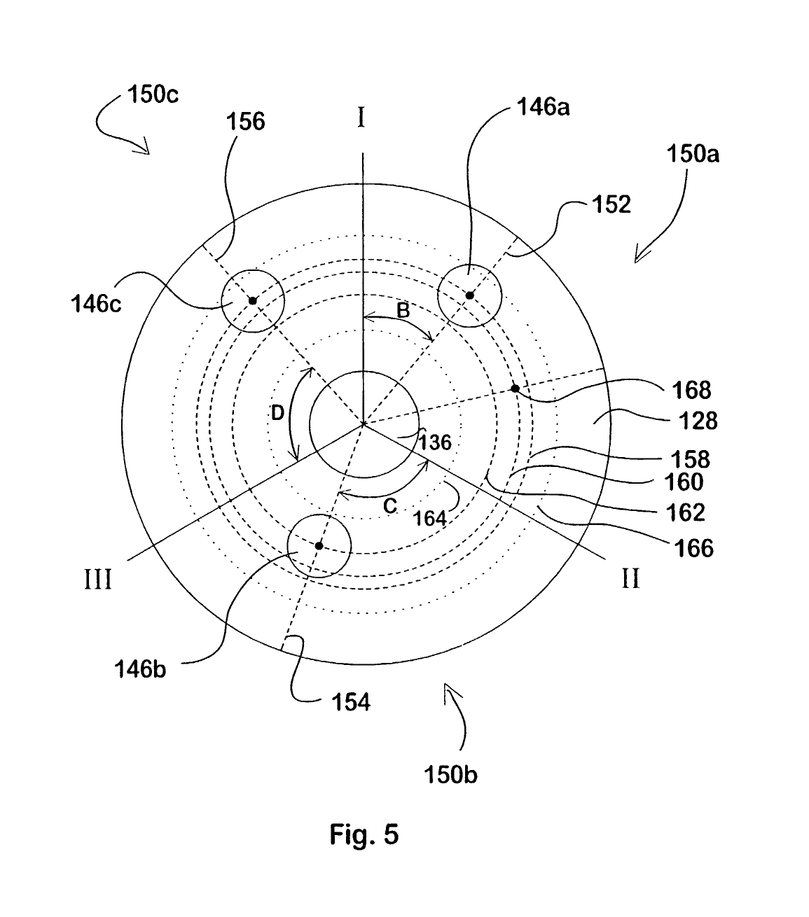

An exemplary embodiment of coupler 124 of first retainer 120 is shown in FIGS. 2, 3, and 4. Coupler 124 includes three apertures or receiving portions 146a, 146b, and 146c formed within body member 122. The receiving portions 146a, 146b, and 146c extend from second axial surface 128 into body member 122. The placement of receiving portions 146a, 146b, and 146c can be varied on second axial surface 128 to provide unique embodiments of first retainer 120. An illustrative embodiment of the parameters used in determining the location of receiving portions 146a, 146b, and 146c is shown in FIG. 5. Additionally the number of receiving portions can be varied to include two portions, three portions, four portions, or higher number of portions.

Referring to FIG. 5, a representative view of second axial surface 128 is shown. Axial surface 128 is defined into three segments 150a, 150b, and 150c. Each segment 150a, 150b, and 150c is an equal sector of second axial surface 128 defined by lines I, II, and III. Alternatively, segments 150a, 150b, and 150c could be unequally sized sectors or could define amorphous non-overlapping regions. As shown in FIG. 5, receiving portions 146a, 146b, and 146c are positioned in a respective segment 150a, 150b, and 150c. By requiring that each receiving portion 146a, 146b, and 146c be located in a different segment 150a, 150b, and 150c, the general disbursement of receiving portions 146a, 146b, and 146c over second axial surface 128 is maintained.

The exact location of receiving portions 146a, 146b, and 146c is determined by selecting both an angular coordinate and a radial coordinate. Receiving portion 146a is positioned at the intersection of a radial line 152 and a circumferential line 158. Receiving portion 146b is positioned at the intersection of a radial line 154 and a circumferential line 162. Receiving portion 146c is positioned at the intersection of a radial line 156 and a circumferential line 158. Radial lines 152, 154 and 156 and circumferential lines 158, 160 and 162 are provided only for clarification. It should be noted that receiving portions 146a, 146b, and 146c can be placed at any angular coordinate and any radial coordinate within the respective sector 150a, 150b, and 150c. However, it preferred to define an acceptable range on both the angular coordinate and radial coordinate. For example, a minimum angle should be maintained from each sector line I, II, III dependent upon the size of receiving portions 146a, 146b, and 146c. The angle chosen should ensure that each of the receiving portions 146a, 146b, and 146c do not overlap with a second one of receiving portions 146a, 146b, and 146c. Additionally, each sector can be configured to include discrete angular coordinates, such as every two degrees. The radial coordinate should be constrained such that receiving portions 146a, 146b, and 146c do not interfere with channel 136 and are completely contained within the bounds of second axial surface 128. As shown, in FIG. 5 a minimum radial coordinate 164 and a maximum radial coordinate 166 are illustrated. An exemplary minimum radial coordinate is 0.200″ (5.08 mm) clearance from channel 136. An exemplary example grid spacing of radial coordinates and angular coordinates is angular coordinates defined at every 2° and radial coordinates every 0.010″ (0.25 mm).

As stated earlier, the placement of receiving portions 146a, 146b, and 146c should be chosen to produce a differing configuration from a first first retainer and a second first retainer. By varying the placement of receiving portions 146a, 146b, and 146c, the chance that an unauthorized user would have a key 190 with a matching configuration is reduced. If all first retainers had the same configuration then an unauthorized user would need to only purchase a second locking device in order to remove a first locking device. Referring back to FIG. 5, receiving portions 146a, 146b, and 146c are positioned at their respective coordinate points. Receiving portion 146a is positioned at the intersection of radial line 152 and circumferential line 158. Receiving portion 146b is positioned at the intersection of radial line 154 and circumferential line 162. Receiving portion 146c is positioned at the intersection of radial line 156 and circumferential line 158. In order to create a second first retainer having a configuration differing from the first first retainer, one or more of the locations of receiving portions 146a, 146b, and 146c should be changed. For example, receiving portion 146a could be moved to coordinate location 168. Although it would be impractical to design all first retainers 120 to have a unique configuration, by having a sufficient number of different configurations the likelihood is reduced that a locking device purchased by an unauthorized user would match a locking device assembled to a bicycle.

The axial configurations of receiving portions 146a, 146b, and 146c are generally cylindrical in configuration. However it is within the scope of the present invention to have receiving portions with different configurations. For example, receiving portions 146a, 146b, and 146c can be triangular or quadrilateral in configuration. Alternatively, the configurations of each receiving portion 146a, 146b, and 146c is different than at least one of the configurations of the other receiving portions. Alternatively, the size of each receiving portion 146a, 146b, and 146c could be different than at least one of the other receiving portions. By varying the size and configuration of receiving portions 146a, 146b, and 146c, the number of unique combinations of receiving portions is greatly increased over the number that can be created by simply varying the radial and angular coordinate locations of receiving portions 146a, 146b, and 146c.

Referring to FIGS. 2, 6, and 7, an exemplary embodiment of second retainer 170 includes a body member 172 and a tab member 174. Body member 172 includes a first axial surface 176, a second axial surface 178, a first radial surface 180, and a second radial surface 182. First axial surface 176, second axial surface 178, radial surface 180, and radial surface 182 are configured similar to first axial surface 126. second axial surface 128, first radial surface 130, and second radial surface 132 of first retainer 120. The similar configuration between body member 172 of second retainer 170 and body member 122 of first retainer 120 is for aesthetic purposes. As is explained below the inclusion of tab member 174 eliminates the requirement that body member 172 be configured to reduce the ability to engage body member l72 with a tool. Body member 172 further includes a channel 184 and a pocket 186 configured similar to the channel 136 and pocket 138 of first retainer 120.

Tab member 174 extends outward from first axial surface 176. Tab member 174 has a generally rectangular cross section on three sides and is bounded by second radial surface 182 on the fourth side. The general shape of tab member 174 is not constrained by any factors. However, in an exemplary embodiment tab member 174 has a longitudinal extent roughly equivalent to the opening of the respective fork member 74, 76, in order to reduce rotation of the second retainer 170 with respect to the respective fork member 74, 76. Additionally, the axial extent of tab member 174 should be large enough to ensure that tab member 174 extends within opening 76 of second fork arm 72.

In an exemplary embodiment, first retainer 120 and second retainer 170 are coupled to the first threaded portion of a conventional axle and the second threaded portion of a conventional axle, respectively. Second retainer 170 is configured to be generally identical to first retainer 120. As such, second retainer 170 includes a coupler generally identical to coupler 124 of first retainer 120 and second retainer 170 does not include a tab member 174. Alternatively, the coupler on second retainer 170 contains a different configuration compared to the coupler 124 on first retainer 120.

Referring to FIGS. 2, 8, and 9, an exemplary embodiment of key 190 includes a body member 192, a tool engagement member 194, and a coupler 196. Body member 192 includes a generally cylindrical configuration defined by radial surface 198 and includes a first axial surface 199. Tool engagement member 194 includes a hexagonally shaped portion 200 sized to be engaged by a wrench tool or socket tool. Alternatively, tool engagement member 194 includes a pocket for receiving the drive of a socket wrench. Alternatively, tool engagement member 194 is configured to engage with a screwdriver. Alternatively, tool engagement member 194 includes a handle similar to a screwdriver.

Coupler 196 includes three protruding portions 202a, 202b, and 202c sized. shaped and positioned to correspond to receiving portions 146a, 146b, and 146c on first retainer 120. By placing each receiving portion 146a, 146b, and 146c on first retainer 120 in a separate segment 150a, 150b, and 150c the load placed on each of protruding portions 202a, 202b, and 202c is more balanced. However the configurations of coupler 196 and coupler 124 should be chosen to mate with each other. In one exemplary embodiment, protruding portions 202a, 202b, and 202c are cylindrical and are 0.094″ (2.39 mm) in diameter. In another exemplary embodiment, protruding portions 202a, 202b, and 202c are cylindrical and are 0.063″ (1.6 mm) in diameter. In yet another exemplary embodiment, protruding portions 202a, 202b, and 202c are cylindrical and are 2 mm in diameter. In yet another exemplary embodiment, protruding portions 202a, 202b, and 202c are cylindrical and are a non-standard diameter.

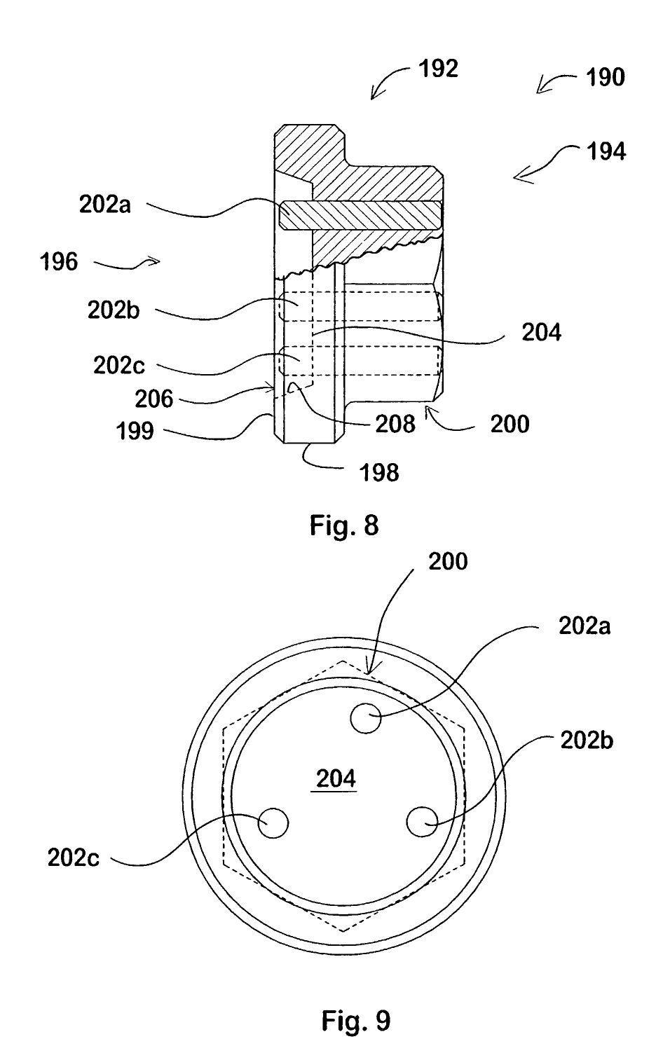

As shown in FIGS. 2 and 8, the protruding portions 202a, 202b, and 202c of coupler 196 extend outward from a second axial surface 204 of body member 192. Second axial surface 204 defines a pocket 206 in body member 192. A radial surface 208 extends between first axial surface 199 and second axial surface 204. Radial surface 208 is configured to generally match first radial surface 130 of first retainer 120. Pocket 206 ensures that key 190 fits squarely on first retainer 120. Alternatively, body member 192 does not include pocket 206 and protruding portions 202a, 202b, and 202c extend from first axial surface 199. The cost of manufacturing is lower when protruding portions 202a, 202b, and 202c extend from first axial surface 199.

In one exemplary embodiment body member 192 is manufactured out of brass and protruding portions 202a, 202b, 202c are steel pins. To assemble key 190, holes are drilled into body member 192 to accept protruding portions 202a, 202b, 202c. Protruding portions 202a, 202b, 202c are then fixably secured to body member 192.

Referring to FIGS. 1 and 2 the operation of locking device 100 is described below. Rod 110 is placed within channel 40 of axle 30 such that first threaded portion 112 extends beyond first threaded portion 32 of axle 30 and such that second threaded portion 114 extends beyond second threaded portion 34 of axle 30. Next, second retainer 170 is partially threaded onto second threaded portion 114 of rod 110. Alternatively, second retainer 170 is permanently assembled to second threaded portion 114 of rod 110 using an adhesive, such as Loctite® 721, manufactured by the Loctite Corporation. By permanently assembling second retainer 120 to rod 110, the overall assembly of locking device 100 is easier. Next, bicycle wheel 10 is positioned such that tab member 174 of second retainer 170 is positioned within opening 76 of second fork member 72, first axial surface 176 is generally flush against second fork member 72 and such that first threaded portion of rod 110 is positioned within opening 74 or first fork member 70. Next, first retainer 120 is partially threaded onto the first threaded portion 112 of rod 110. Alternatively, before first retainer 120 is partially threaded onto rod 110 channel 104 in washer 102 is positioned around first threaded portion 112 of rod 110 and washer 102 is flush against surface 78 of first fork member 70. Next, key 190 is positioned such that coupler 194 of key 190 engages coupler 124 of first retainer 120. Next a tool is engaged with tool engagement member 194 of key 190 such that the tool tightens first retainer 120 against surface 78 of first fork member 70 or washer 102 if washer 102 is included. It should be noted that the tab member 174 of second retainer 170 prevents the rotation of second retainer 170 while first retainer 120 is tightened with the tool. As such, to disassemble locking device 100 only one tool and key 190 is required. Finally, key 190 is uncoupled from first retainer 120 and stored until required again.

Locking device 100 is disassembled to allow bicycle wheel 10 to be removed from bicycle frame 60 by an authorized user in the following manner. Key 190 is positioned such that coupler 194 of key 190 engages coupler 124 of first retainer 120. Next, a tool is engaged with tool engagement member 194 of key 190 such that by turning the tool key 190 moves first retainer 120 away from surface 78 of first fork member 70 or washer 102 if washer 102 is included. Once first retainer 120 is backed away, bicycle axle 30 is free to exit from fork openings 74 and 76. It should be noted that the tab member 174 of second retainer 170 prevents the rotation of second retainer 170 while first retainer 120 is back away with the tool. As such, to disassemble locking device 100 only one tool and key 190 is required. Alternatively, key 190 is configured to include a lever arm which would eliminate the need for a separate tool. Finally, key 190 is uncoupled from first retainer 120 and stored until required again.

In an exemplary embodiment, second retainer 170 is generally identical to first retainer 120. As such, second retainer 170 includes a coupler similar to coupler 124 and second retainer 170 does not include a tab member 174. During assembly, both first retainer 120 and second retainer 170 are threaded onto the axle of a bicycle and tightened against the bicycle frame 60 with key 190. Alternatively, two keys are used to tighten first retainer 120 and second retainer 170 against bicycle frame 60. Alternatively, first retainer 120 and second retainer 170 comprise couplers having different configurations. As such first retainer 120 and second retainer 170 are tightened against bicycle frame 60 with two keys, one having a coupler configured to match the coupler of first retainer 120 and one having a coupler configured to match the coupler of second retainer 170.

When locking device 100 is assembled to hold bicycle wheel 10 onto bicycle frame 60, pocket 77 on first fork member 70 reduces the likelihood that first retainer 120 will be removed by an unauthorized user. Pocket surface 80 at least partially prevents access to second radial surface 132 of first retainer 120. As such, if first fork member 70 includes a pocket 77, the axial extent of second radial surface 132 can be chosen to generally be less than or equal to the axial extent of pocket surface 80. Alternatively to pocket 77, first fork member 70 can include a wall protruding outward from fork surface 75 which obstructs a tool from engaging first radial surface 130 and second radial surface 132 of first retainer 120.

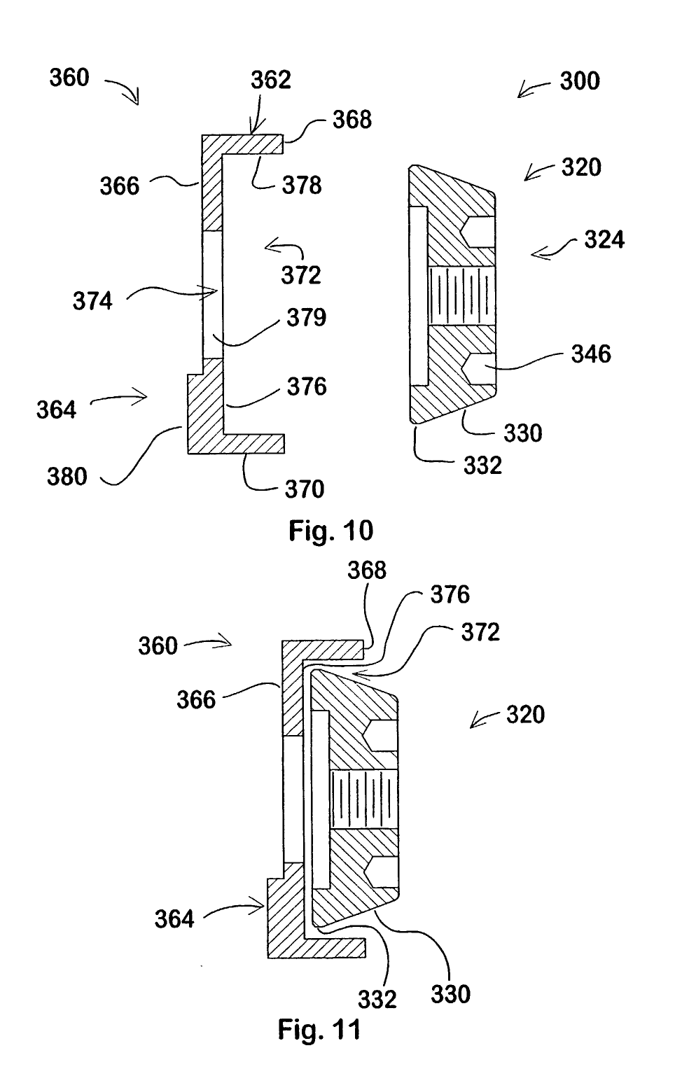

A second illustrative embodiment 300 of a locking device is partially shown in FIGS. 10 and 11. Embodiment 300 includes a threaded rod (not shown in FIGS. 10 and 11) being generally identical to threaded rod 110, a first retainer 320 being generally identical to first retainer 120, a second retainer (not shown in FIGS. 10 and 11) being generally identical to second retainer 170, a key (not shown in FIGS. 10 and 11) being generally identical to key 190, and a sleeve member 360.

Sleeve member 360 includes a body member 362 and a tab member 364. Body member 362 includes a first axial surface 366, a second axial surface 368 and a first radial surface 370. Body member 362 further includes a pocket 372 and a channel 374. Pocket 372 is defined by a third axial surface 376 and a second radial surface 378. Channel 374 extends axially though sleeve 360 and is defined by a third radial surface 379. Channel 374 is sized such that the first threaded portion of the rod is able to pass therethrough.

Pocket 372 is sized to receive first retainer 320. The axial separation between second axial surface 368 and third axial surface 376 is chosen such that second radial surface 332 of first retainer 320 is completely overlapped by body member 362 of sleeve 360 when assembled, as shown in FIG. 11. By overlapping second radial surface 332, sleeve 360 prevents an unauthorized user from engaging second radial surface 332 with a tool. Alternatively, the axial separation between second axial surface 368 and third axial surface 376 is chosen such that both first radial surface 330 of first retainer 320 and second radial surface 332 of first retainer 320 are completely overlapped by body member 362 of sleeve 360. By overlapping both first radial surface 330 and second radial surface 332, sleeve 360 prevents an unauthorized user from engaging either first radial surface 330 or second radial surface 332 with a tool.

Tab member 364 of sleeve 360 extends from first axial surface 366 on body member 362 and is generally identical to tab member 174 on second retainer 170 of embodiment 100. Tab member 364 extends outward from first axial surface 366 up to fourth axial surface 380. The separation between first axial surface 366 and fourth axial surface 380 is chosen such that tab member 364 extends into opening 74 on first fork member 72 shown in FIG. 1.

Coupler 324 of first retainer 320 may include protruding portions protruding outward from second axial surface 328 as opposed to apertures or receiving portions 346 or coupler 324 may include both receiving portions and protruding portions. Preferably coupler 324 includes receiving portions as opposed to protruding portions because two or more protruding portions could be easier to grip with a tool. Additionally the number of receiving portions or protruding portions can be varied to include two portions, three portions, four portions, or higher number of portions.

Referring to FIGS. 1, 10 and 11 the operation of locking device 300 is described below. The rod is placed within channel 40 of axle 30 such that the first threaded portion of the rod extends beyond first threaded portion 32 of axle 30 and such the second threaded portion of rod extends beyond second threaded portion 34 of axle 30. Next, the second retainer is partially threaded onto the second threaded portion of the rod. Alternatively, the second retainer is permanently assembled to the second threaded portion of the rod using an adhesive, such as Loctite® 721, manufactured by the Loctite Corporation. By permanently assembling the second retainer to the rod, the overall assembly of locking device 300 is easier. Next, bicycle wheel 10 is positioned such that the tab member of the second retainer is positioned within opening 76 of second fork member 72, the second retainer is generally flush against second fork member 72 and such that the first threaded portion of the rod is positioned within opening 74 or first fork member 70. Next, sleeve 360 is placed over the first threaded portion of the rod such that tab member 364 of sleeve 360 is positioned within opening 74 of first fork member 70. Next, first retainer 320 is partially threaded onto the first threaded portion of the rod. Next, the key is positioned such that the coupler of the key engages coupler 324 of first retainer 320. Next, a tool is engaged with the tool engagement member of the key such that by timing the key first retainer 320 is tightened against sleeve 360 and hence against surface 78 of first fork member 70. Finally, the key is uncoupled from first retainer 320 and stored until required again.

The tab member on the second retainer and tab member 364 on sleeve 360 prevent the rotation of the second retainer and the sleeve, respectively, when either the second retainer or the sleeve is attempted to gripped with a tool. In order to compromise locking device 300, an unauthorized user would either have to dislodge tab member 364 or the tab member on the second retainer or break the second retainer or sleeve 360.

It should be noted that the inclusion of sleeve 360 permits first retainer 320 to have various radial configurations and still function properly. For example, first retainer 320 could have a smooth, cylindrical radial surface, as long as the diameter of the radial surface is smaller than the diameter of radial surface 378 of sleeve 360. The radial configuration of first retainer 320 could also be hexagonal, as long as, the separation between the hexagonal surfaces and radial surface 378 is small enough to prevent the introduction of a socket or other tool between first retainer 320 and radial surface 378 of sleeve 360.

In an exemplary embodiment, the second retainer is generally identical to first retainer 320. As such, the second retainer includes a coupler similar to coupler 324 and the second retainer does not include a tab member. During assembly, both first retainer 320 and the second retainer are threaded onto the axle of a bicycle and tightened against the bicycle frame 60 with key 190. Alternatively, a first sleeve 360 is inserted between first retainer 120 and bicycle frame 60 and a second sleeve 360 is inserted between second retainer 170 and bicycle frame 60. Alternatively, two keys are used to tighten first retainer 120 and second retainer 170 against bicycle frame 60 or first and second sleeves 360. Alternatively, first retainer 120 and second retainer 170 comprise couplers having different configurations. As such first retainer 120 and second retainer 170 are tightened against bicycle frame 60 or first and second sleeves 360 with two keys, one having a coupler configured to match the coupler of first retainer 120 and one having a coupler configured to match the coupler of second retainer 170.

Locking device 300 is disassembled to allow bicycle wheel 10 to be removed from bicycle frame 60 by an authorized user in the following manner. The key is positioned such that the coupler of the key engages coupler 324 of first retainer 320. Next, a tool is engaged with the tool engagement member of the key such that by turning the key first retainer 320 is moved away from surface 78 of first fork member 70. Once first retainer 320 is backed away, bicycle axle 30 is free to exit from fork openings 74 and 76. Finally, the key is uncoupled from first retainer 320 and stored until required again.

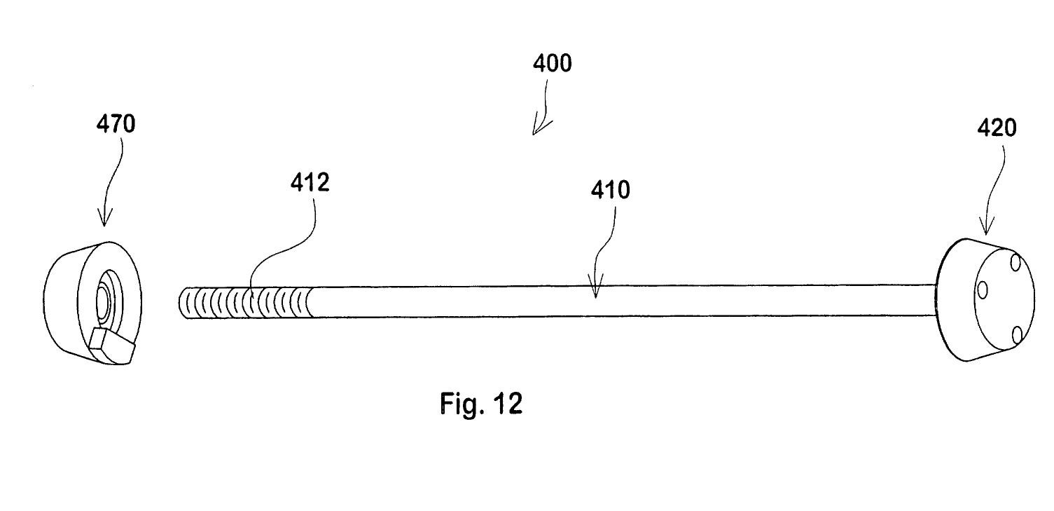

FIG. 12 shows a third illustrative embodiment 400 of a locking device. Locking device 400 includes a rod 410 having a first threaded portion 412, a first retainer 420 fixably coupled to rod 410 and being generally identical to first retainer 120, a second retainer 470 generally identical to second retainer 170, and a key generally identical to key 190 (not shown if FIG. 12). Alternatively, locking device 400 further includes a sleeve (not shown in FIG. 12) generally identical to sleeve 360.

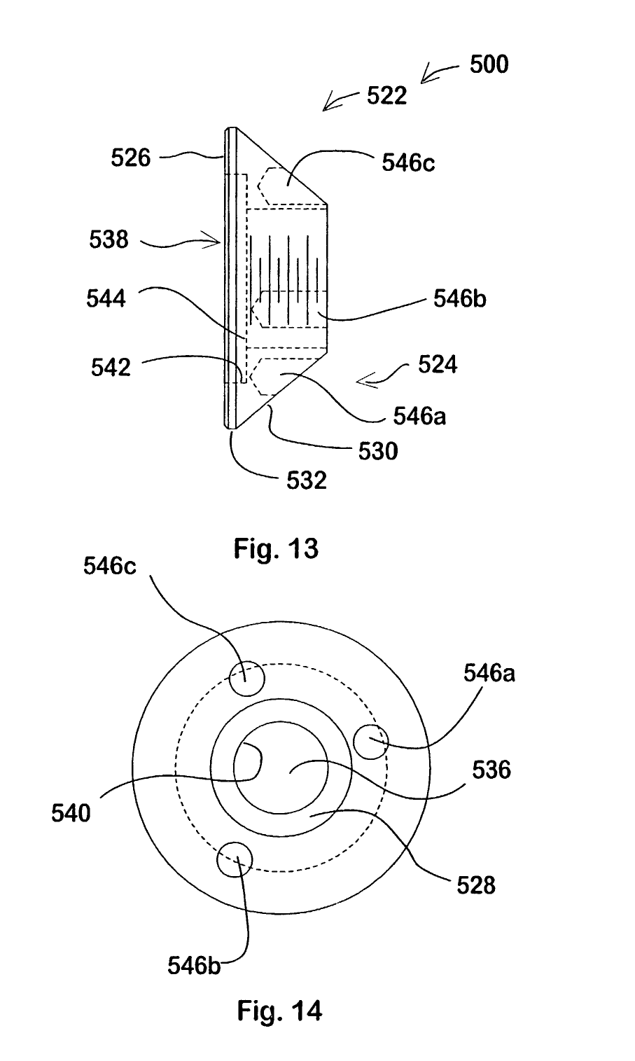

FIGS. 13 and 14 provide an additional exemplary embodiment of a first retainer 520. First retainer 520 includes a body member 522 and a coupler 524. Body member 522 includes a generally circular first axial surface 526, a generally circular second axial surface 528, a first radial surface 530 and a second radial surface 532. First axial surface 526 and second axial surface 528 have a generally circular configuration. Second axial surface 528 has a generally smaller diameter compared to the diameter of first axial surface 526, thereby causing radial surface 530 to have a frusto-conical shape. The axial tapering of the frusto-conical configuration reduces the axial extent of first retainer 520 to which a tool having a linear profile can exert pressure.

Body member 522 further includes a channel 536 and a pocket 538. Channel 536 is defined by a radially, inward-facing surface 540 that is concentric with radial surfaces 530 and 532 and which extends from first axial surface 526 through to second axial surface 528. Channel 536 includes a threaded portion configured to couple with the first threaded portion of the rod of locking device 500. Pocket 538 is defined by a third axial surface 542 and a second radially inward-facing surface 544. Pocket 538 is configured to provide clearance for axle 30 when first retainer 520 is coupled to axle 30.

Coupler 524 of first retainer 520 includes three apertures or receiving portions 546a, 546b, and 546c formed within body member 522. The receiving portions 546a, 546b, and 546c extend from either second axial surface 528 or first radial surface 530 into body member 522. By allowing receiving portions 546a, 546b, and 546c to intersect with radial surface 530 instead of only axial surface 528, as in locking device 100, the overall radial extent of first retainer 520 is reduced.

The placement of receiving portions 546a, 546b, and 546c is varied on second axial surface 528 and first radial surface 530 to provide unique embodiments of first retainer 520. The placement criteria of receiving portions 546a, 546b, and 546c on second axial surface 528 and first radial surface 530 is similar to the angular and radial coordinates shown in FIG. 5.

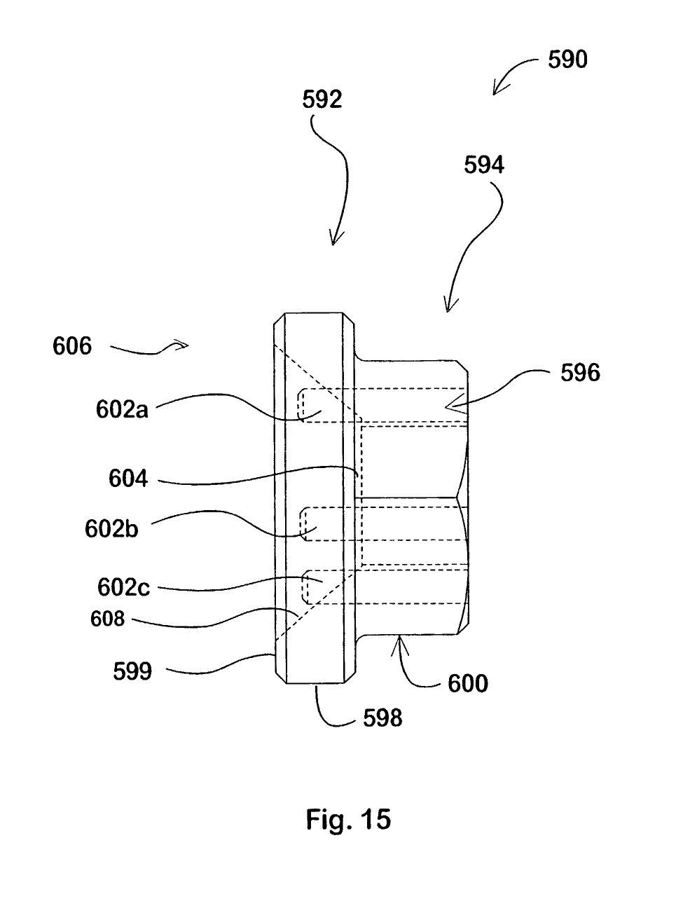

Referring to FIG. 15, key 590 of locking device 500 includes a body member 592, a tool engagement member 594, and a coupler 596. Body member 592 includes a generally cylindrical configuration defined by radial surface 598 and includes a first axial surface 599. Tool engagement member 594 includes a hexagonally shaped portion 600 sized to be engaged by a wrench tool or socket tool. Coupler 596 includes three protruding portions 602a, 602b, and 602c sized, shaped and positioned to correspond to receiving portions 546a, 546b, and 546c. The configurations of coupler 596 and coupler 524 are chosen to mate with each other.

As shown in FIG. 15, the protruding portions 602a, 602b, and 602c of coupler 596 extend outward from a second axial surface 604 of body member 692. Second axial surface 604 defines a pocket 606 in body member 592. A radial surface 608 extends between first axial surface 599 and second axial surface 604 and is configured to generally match first radial surface 530 of first retainer 520. Alternatively, body member 592 does not include pocket 506 and protruding portions 602a, 602b, and 602c extend from first axial surface 599.

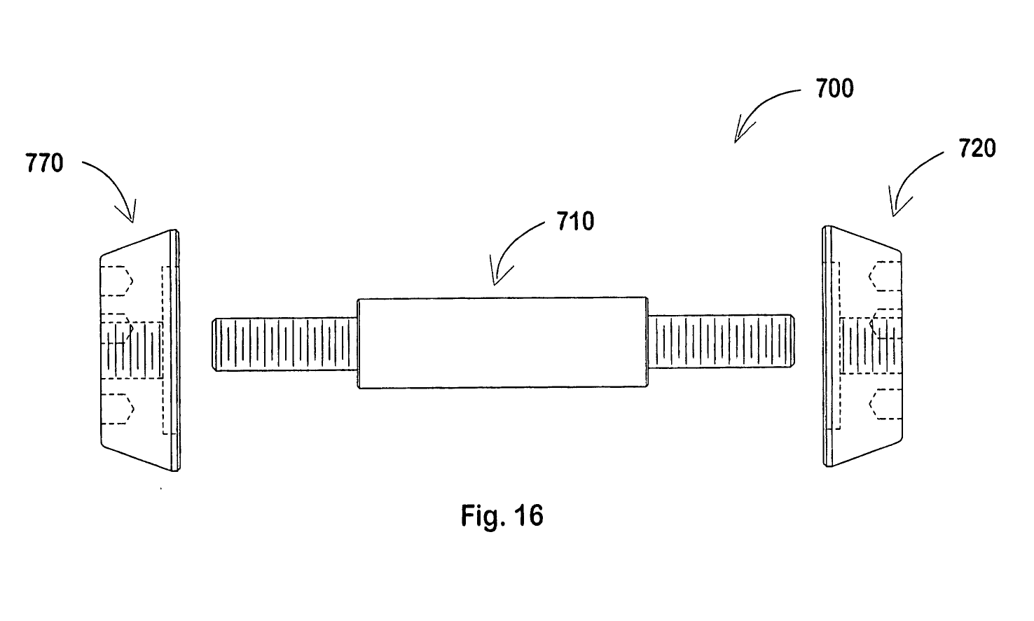

Referring to FIG. 16, another illustrative embodiment of locking device 700 is shown. Locking device 700 includes a rod 710 generally similar to rod 110 of locking device 100, a first retainer 720 generally similar to first retainer 120 of locking device 100, a second retainer 170 generally similar to first retainer 120 of locking device 100, and a key (not shown in FIG. 16). Locking device 700 is used in applications wherein there is not an opening, such as fork openings 74 and 76, to receive the tab member on the second retainer or the sleeve. For example, locking device 700 may be used to secure a seat to the bicycle frame.

While the invention has been illustrated and described in detail in the drawings and foregoing description, such illustration and description is to be considered as exemplary and not restrictive in character, it being understood that only exemplary embodiments have been shown and described and that all changes and modifications that come within the spirit of the invention are desired to be protected.

1. A locking device configured to secure a bicycle wheel having an hub with an axial channel to a bicycle frame, the locking device comprising:
a rod adapted to pass through the axial channel of the hub and comprising a first threaded portion and a second threaded portion;
a first retainer comprising a body member and a coupler,
the body member being configured to be coupled to the first threaded portion of the rod, and
the coupler comprising a plurality of receiving portions;
a second retainer comprising a body member configured to be coupled to the second threaded portion of the rod and a tab member configured to limit rotation of the second retainer relative to the frame; and
a key comprising a plurality of protruding portions, each one of the receiving portions of the first retainer configured to couple one of the protruding portions of the key.

2. The locking device of claim 1, wherein the body member of the first retainer further includes a first frusto-conical radial surface.

3. The locking device of claim 1, wherein the coupler of the first retainer includes at least three receiving portions and wherein the receiving portions are positioned such that each receiving portion is positioned within a different one of at least three segments of the body member.

4. The locking device of claim 3, wherein the segments are sectors of a circle and the receiving portions are positioned based upon an angular coordinate and a radial coordinate.

5. The locking device of c aim 4, wherein the body member further includes a frusto-conical radial surface.

6. The locking device of claim 1, wherein the receiving portions of the first retainer are generally cylindrical and wherein a first one of the receiving portions has a first diameter and a second one of the receiving portions has a second diameter different from the first diameter.

7. The locking device of claim 1, wherein a first one of the receiving portions has a first configuration and a second one of the receiving portions a has second configuration different from the first configuration.

8. A locking device configured to secure a bicycle wheel having a hub with an axial channel to a bicycle frame, the locking device comprising:
a rod adapted to pass through the axial channel of the hub and comprising a first threaded portion and a second threaded portion;
a first retainer comprising a body member and a coupler, the body member being configured to be coupled to the first threaded portion of the rod;
a second retainer comprising a body member configured to be coupled to the second threaded portion of the rod and a tab member configured to limit rotation of the second retainer relative to the frame;
a key comprising a body member and a coupler configured to couple the coupler of the first retainer; and
a sleeve comprising a body member and a tab member,
the body member configured to partially receive the first retainer, and
the tab member configured to limit rotation of the sleeve relative to the frame.

9. The locking device of claim 8, wherein the body member of the sleeve is configured to completely receive the body member of the first retainer.

10. The locking device of claim 9, wherein the coupler of the first retainer comprises a plurality of receiving portions and wherein the coupler of the key includes a plurality of protruding portions configured to couple with the receiving portions of the first retainer.

11. A locking device configured to secure a bicycle wheel having an axle with a first threaded portion and a second threaded portion to a bicycle frame, the locking device comprising:
a first retainer comprising a body member and a coupler,
the body member being adapted to be coupled to the first threaded portion of the axle, and
the coupler comprising a plurality of receiving portions positioned in a first configuration;
a second retainer comprising a body member adapted to be coupled to the second threaded portion of the axle and a coupler comprising a plurality of receiving portions positioned in a second configuration, the second configuration matching the first configuration of the first retainer; and
a key comprising a plurality of protruding portions, each one of the receiving portions of the first retainer configured to couple one of the protruding portions of the key.

12. The locking device of claim 11, wherein the body member of the first retainer further includes a frusto-conical radial surface and the body member of the second retainer further includes a frusto-conical radial surface.

13. The locking device of claim 11, wherein the coupler of the first retainer includes at least three receiving portions and wherein the receiving portions are positioned such that each receiving portion is positioned within a different one of at least three segments of the body member.

14. The locking device of claim 13, wherein the segments are sectors of a circle and the receiving portions are positioned based upon an angular coordinate and a radial coordinate.

15. The locking device of claim 11, wherein the receiving portions of the first retainer are generally cylindrical and wherein a first one of the receiving portions has a first diameter and a second one of the receiving portions has a second diameter different from the first diameter.

16. A method for securing a bicycle wheel having an hub with an axial channel to a bicycle frame having a first receiving portion and a second receiving portion, the method comprising the steps of:
placing a rod having first threaded portion and a second threaded portion within the axial channel of the wheel;
securing a second retainer to the second threaded portion of the axle;
locating a tab member of the second retainer adjacent the second receiving portion of the frame, the tab member of the second retainer adapted to limit the rotation of the second retainer relative to the frame;
securing a first retainer to the first threaded portion of the axle;
engaging a plurality of receiving portions of the first retainer with a key including a plurality of protruding portions; and
turning the key to tighten the first retainer against the bicycle frame.

17. The method of claim 16, further comprising the steps of:
positioning a sleeve between the first retainer and the bicycle frame; and
locating a tab member of the sleeve adjacent the first receiving portion of the frame, the tab member of the sleeve adapted to limit the rotation of the sleeve relative to the frame.

18. A locking device configured to secure a bicycle wheel having an axle with a first threaded portion and a second threaded portion to a bicycle frame, the locking device comprising:
a first retainer comprising a body member and a coupler, the body member being adapted to be coupled to the first threaded portion of the axle;
a second retainer comprising a body member adapted to be coupled to the second threaded portion of the axle and a coupler,
a key comprising a body member and a coupler, the coupler being configured to couple the coupler of the first retainer and the coupler of the second retainer; and
a sleeve comprising a body member and a tab member, the body member configured to partially receive the first retainer, and the tab member adapted to limit rotation of the sleeve relative to the frame.

19. The locking device of claim 18, wherein the body member of the sleeve is configured to completely receive the body member of the first retainer.

20. The locking device of claim 19, wherein the coupler of the first retainer comprises a plurality of receiving portions and wherein the coupler of the key includes a plurality of protruding portions configured to couple with the receiving portions of the first retainer.

21. The locking device of claim 18, the locking device further comprising a second sleeve comprising a body member and a tab member, the body member configured to partially receive the body member of the second retainer, and the tab member adapted to limit rotation of the second sleeve relative to the frame.

22. A method of providing a plurality of retainers and keys configured to secure a component on a bicycle, the method comprising the steps of:
providing a plurality of keys, each key including a coupler having a plurality of protruding portions;
providing a plurality of retainers, each retainer having a first axial surface and a second axial surface axially spaced apart from the first axial surface, the second axial surface defining a plurality of sectors; and
for each of the plurality of retainers, providing each sector of the second axial surface with an aperture configured to receive one of the protruding portions of one of the plurality of keys, each of the apertures being positioned at a radial coordinate and an angular coordinate, the plurality of apertures of each retainer defining a unique configuration and the protrusions of each key defining a unique configuration that matches at least one of the unique configurations of the apertures of at least one of the plurality of retainers.
